(19) United States
(12) Patent Application Publication
(10) Pub. No.: US 2006/0134373 A1
(43) Pub. Date: Jun. 22, 2006

(54) Finish protector, and method

(76) Inventors: Joseph Paul Roberts, Roselle, IL (US); Kevin Mark Slota, Roselle, IL (US)

Correspondence Address: DAVID E. HERRON II, PO BOX 2778, KANSAS CITY, KS, 66110, US

(21) Appl. No.: 11/318,170

(22) Filed: Dec. 24, 2005

Related U.S. Application Data
(63) Continuation-in-part of application No. 10/715,196, filed on Nov. 17, 2003, now abandoned.

(51) Int. Cl. B32B 33/00; B32B 27/12; B32B 5/02

(52) U.S. Cl. 428/85; 442/151; 427/207.1; 427/289

(57) ABSTRACT

The invention is a device for protecting a selected surface of a musical instrument, and a method of making such a device.

### SUMMARY OF THE INVENTION

The invention is a device for protecting a surface of a musical instrument, and a method for making such a device.

### THE INVENTIVE DEVICE

The inventive device includes a pliable planar sheet having an inner face configured to engage a surface of a musical instrument. The sheet also has an outer face, and fabric is positioned on at least a portion (preferably substantially covering) the outer face. The invention also includes a thermoplastic elastomer positioned on at least a portion of the inner face and configured to removably adhere to the surface.

Optionally, the inventive device may include an intermediate layer of cushioning material positioned between the inner face and the outer face. In preferred embodiments of the invention, the device will be used with a guitar bass, banjo, violin, ukulele, or mandolin.

In a preferred embodiment of the inventive device, a thermoplastic elastomer engages within fibrous substrate of the fabric and substantially covers the entire inner face. The thermoplastic elastomer may comprise any known low-tack TPE, such as a combination of mineral oil and a styrene-ethylene/butylene-styrene block copolymer.

In a preferred embodiment of the device, the fabric includes velveteen; of course, other fabrics may be used, such as denim, cotton, muslin, corduroy, brushed leather, suede, or the like.

### THE INVENTIVE METHOD

The inventive method includes the steps of providing a fabric having a first face and a second face, and heating a pelletized thermoplastic elastomer. The method will also include the step of applying a thin film of molten thermoplastic elastomer to the first face of the fabric to form a sheet.

Next, the sheet is cooled and spread flat, where a stamp is used to stamp (or score) a pattern onto the sheet. The stamped/scored figures are then removed from the sheet. These figures are the above-described device(s).

Optionally, the inventive method may also include the step of removably adhering a backing to the first face of the fabric.

In a second preferred embodiment of the method, the invention will include the step of providing an unwind roll containing the fabric rolled thereon, and a rewind roll distal the unwind roll for receiving the sheet. In this embodiment, the fabric is rolled from the unwind roll and the sheet is received on the rewind roll.

In a preferred embodiment, the invention will include the step of positioning a die to spray the molten thermoplastic isomer onto the first face of the fabric; and, also positioning a hot roll between the unwind roll and the rewind roll. This hot roll engage (and warms) the fabric by applying heat to the second face.

Optionally, the method may include the step of positioning the hot roll upstream of the dye, so that a portion of the fabric first engages the hot roll before molten thermoplastic isomer is sprayed onto the portion. Additionally a chill roll may be placed between the unwind roll and the rewind roll so that the chill roll engages the thin film.

Of course, the method may also include the step of positioning the stamped figure (i.e., the inventive device) on a selected surface of the musical instrument, such as a guitar, bass, banjo, violin, ukulele, or mandolin.

Various choices exist for the fabric and pelletized thermoplastic elastomer. For example, the fabric may be velveteen, and the thermoplastic elastomer may comprise styrene-ethylene/butylene-styrene block copolymer.

Other objects, advantages and novel features of the present invention will become apparent from the following detailed description of the invention when considered in conjunction with the accompanying drawings.

### BRIEF DESCRIPTION OF THE DRAWINGS

FIG. 1 is a plan view of the inventive device, according to the principles of the invention.

FIG. 2 is a plan views of the inventive device, as viewed from the opposite side as FIG. 1.

FIGS. 3-5 are respective perspective views showing layers of embodiments of the inventive device.

FIG. 6 is a perspective view showing how the layers of the device are assembled.

FIG. 7 shows the stamping of the device from sheets.

### DETAILED DESCRIPTION OF THE PREFERRED EMBODIMENTS

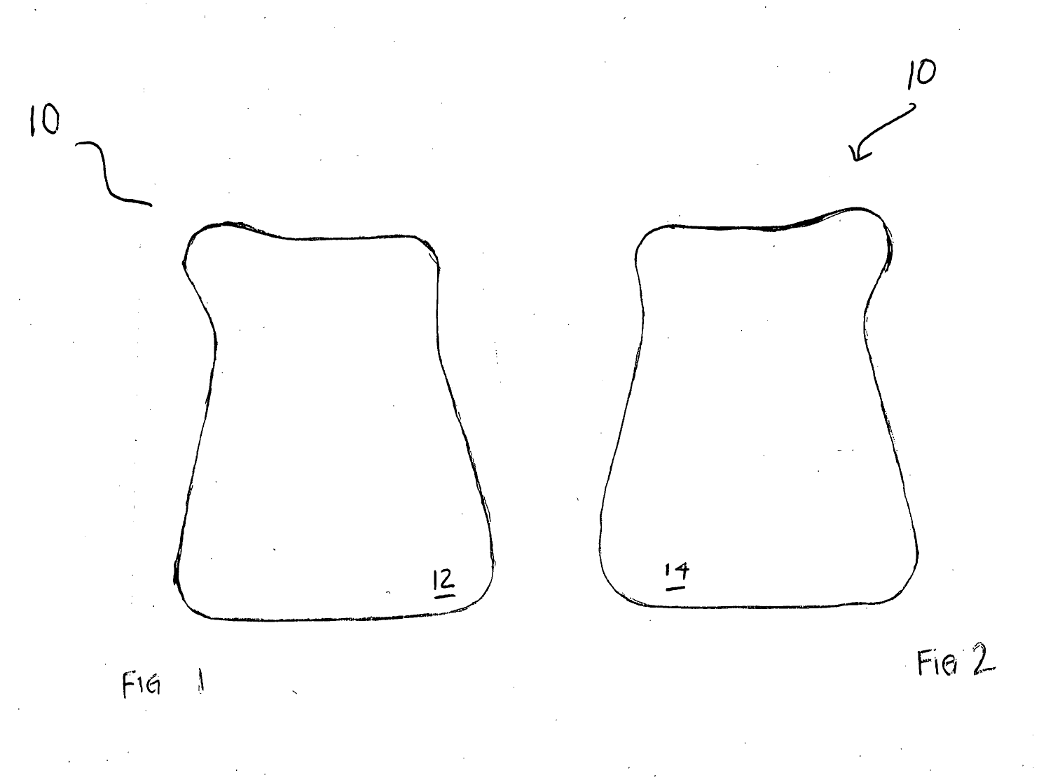

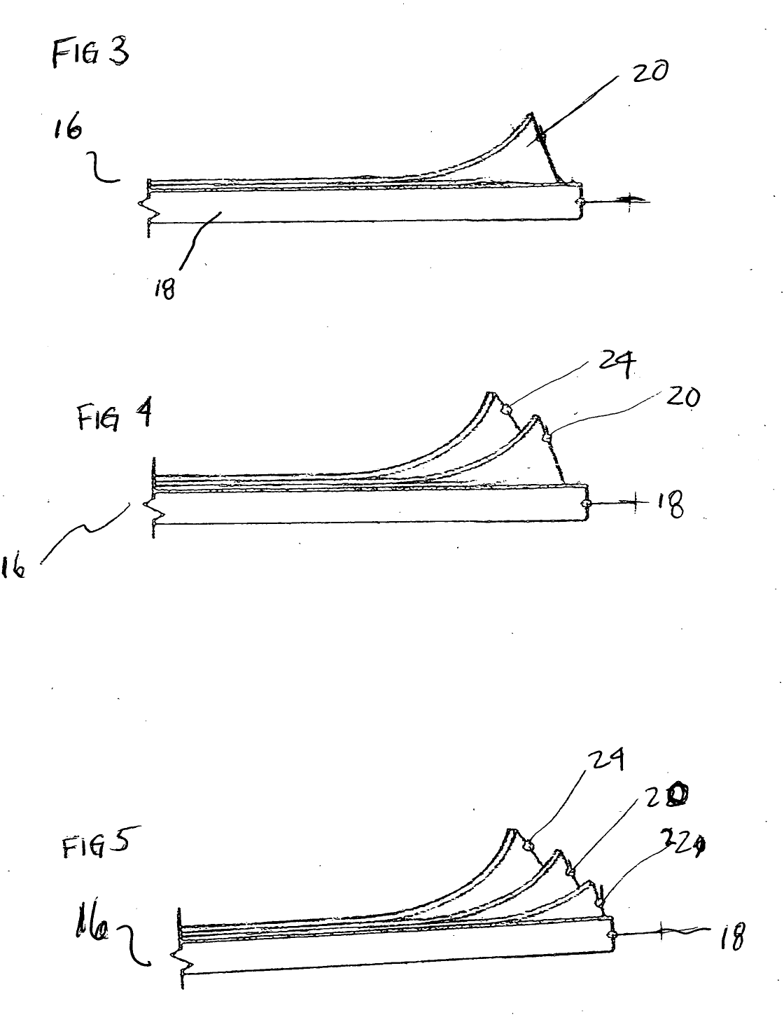

FIGS. 1 and 2 show plan views of the basic preferred shape of the inventive device, according to the principles of the invention. Specifically, FIG. 1 shows a first face 12, which will generally bear a fabric-like cover, such as velveteen or the like. In contrast, FIG. 2 shows a plan view of second face, which will generally have a non-tack or low-tack material such as a thermoplastic elastomer. Of course, the coverings of first and second 12,14 may be reversed if desired, in order to accommodate a left handed guitarist for example

FIG. 3 shows a perspective view of a sheet 16 and its component. As discussed herein, the device 10 will be stamped from a sheet 16 that will comprise a plurality of layers. The outer layer 18 comprises a general fabric finish, such as velveteen, denim, curdoroy, or the like. The fabric layer 18 of the sheet 16 is coated with a layer 20 of a thermoplastic elastomer.

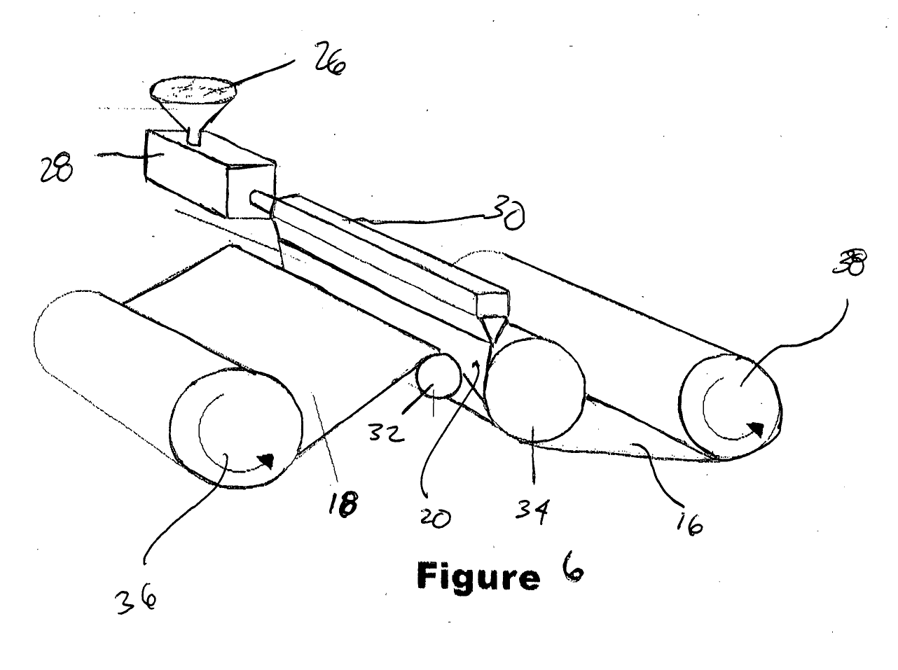

FIG. 4 shows a perspective view of a sheet 16 comprising a fabric layer 18 coated with a layer 20 of low-tack thermoplastic elastomer; this layer 20 is then protectively coated with a cover 24 over the layer 20. This cover 24 is generally a clear pliable plastic or polyester that is removably adherable to the layer 20. When a musician desires to attach the device 10 to a musical instrument, the cover 24 from the device 10 and selectively places the device 10 on the musical instrument in order to protect a selected area of the musical instrument (not shown) from scratches, dings, and other harms. The thermoplastic elastomer of layer 20 is selected so that it will adhere to the musical instrument without damaging its finish.

FIG. 5 shows a perspective view of another preferred embodiment of a sheet 16 from which devices 10 may be made. In this embodiment, sheet 16 includes a fabric layer 18 coated with a thermoplastic elastomer layer 20 with a cover 24 engaging the thermoplastic elastomer layer 20. In this embodiment, a cushioning layer 22 is first applied to the fabric layer 18 in order to provide additional protection against dings or dents to the musical instrument.

FIG. 6 is a detailed perspective view showing how sheets 16 are made. Fabric 18 is provided on an unwind roll 36. The fabric rolls across a hot roll 32, then under a chill roll 34, and is received on a rewind roll 38.

Still referring to FIG. 6, pelletized thermoplastic elastomer 26 is inserted into an extruder 28 which heats and at least partially liquefies the thermoplastic elastomer. A die 30 then expels the thermoplastic elastomer layer 20 onto the fabric 18 to form a sheet 16 that will be received on the rewind roll 38. In order to expedite the cooling of the product, a chill roll 34 is positioned to engage the sheet 16 and smooth the thermoplastic elastomer layer 20 to form a smooth and generally uniform sheet 16.

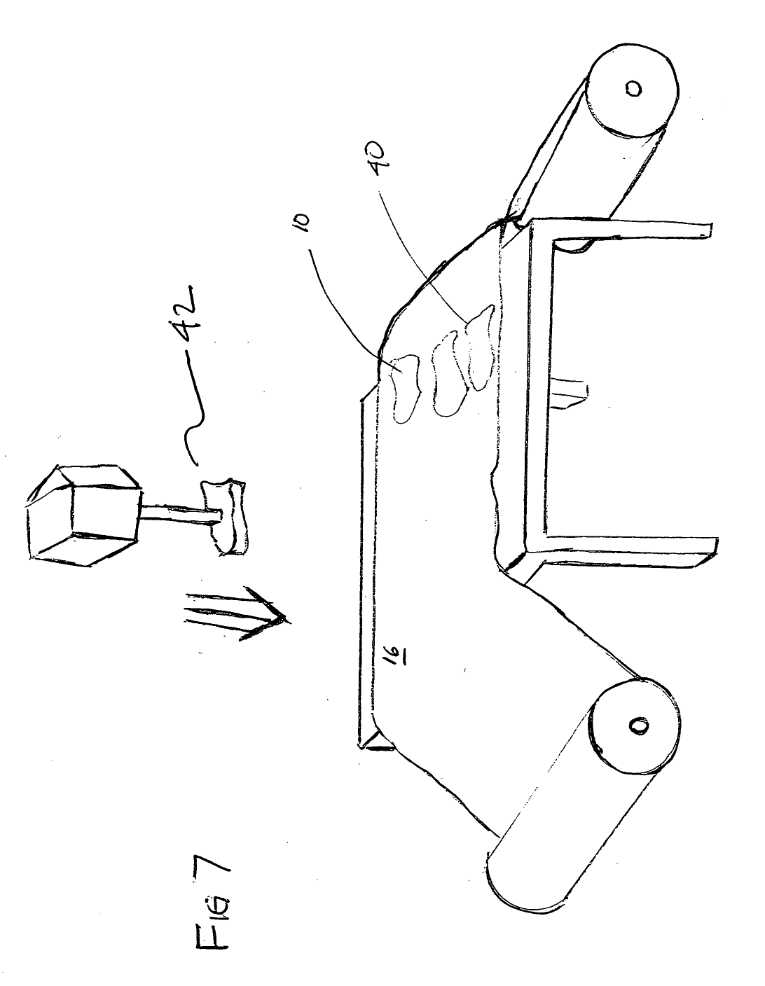

FIG. 7 shows a perspective view giving a general example of how devices 10 may be stamped from the sheets. In preferred embodiments of the invention, the cover 24 is applied to the sheet 16 before it is laid flat for stamping. A stamp 42 then creates a scored outline 40 onto the sheet, where a device 10 may be removed.

Having described and illustrated the invention in detail, it is to be understood that the above and foregoing is for illustration and demonstration only. The descriptions herein are not intended to limit the breadth of this invention. The scope and breadth of the invention shall be limited only by the appended claims.

My invention is:

1. A device for protecting a surface of a musical instrument, the device including:
a pliable, planar sheet having
an inner face configured to engage the surface, and
an outer face; and,
a fabric positioned on at least a portion of the outer face;
a thermoplastic elastomer positioned on at least a portion of the inner face and configured to removably adhere to the surface.

2. The device as in claim 1, further comprising
an intermediate layer of cushioning material positioned between the inner face and the outer face.

3. The device as in claim 1, wherein the instrument is one of
a guitar, bass, banjo, violin, ukulele, or mandolin.

4. The device as in claim 1, wherein,
thermoplastic elastomer engages within fibrous substrate of the fabric and substantially covers the entire inner face.

5. The device as in claim 1, wherein the inner face consists of the thermoplastic elastomer.

6. The device as in claim 1, the thermoplastic elastomer comprising styrene-ethylene/butylene-styrene block copolymer.

7. The device as in claim 6, the thermoplastic elastomer comprising mineral oil.

8. The device as in claim 1, wherein the fabric includes velveteen.

9. A method of making a finish protector for a musical instrument, the method comprising the steps of:
providing a fabric having a first face and a second face;
heating a pelletized thermoplastic elastomer;
applying a thin film of molten thermoplastic elastomer to the first face of the fabric to form a sheet;
cooling the sheet;
spreading the sheet flat;
stamping a selected pattern onto the sheet;
removing a stamped figure of the selected pattern from the sheet.

10. The method as in claim 9, further comprising the step of
removably adhering a backing to the first face of the fabric.

11. The method as in claim 9, further comprising the step of
providing an unwind roll containing the fabric rolled thereon;
positioning a rewind roll distal the unwind roll for receiving the sheet; wherein,
the fabric is rolled from the unwind roll and the sheet is received on the rewind roll.

12. The method as in claim 11, further including the steps of
positioning a dye to spray the molten thermoplastic isomer onto the first face of the fabric; and,
positioning a hot roll between the unwind roll and the rewind roll, the hot roll configured to engage the second face of the fabric.

13. The method as in claim 12, further comprising the step of
positioning the hot roll upstream of the dye, so that a portion of the fabric first engages the hot roll before molten thermoplastic isomer is sprayed onto the portion.

14. The method as in claim 11, further comprising the step of
positioning a chill roll between the unwind roll and the rewind roll so that the chill roll engages the thin film.

15. The method as in claim 9, further comprising the step of positioning the stamped figure on a selected surface of the musical instrument.

16. The method as in claim 15, wherein the musical instrument is one of a guitar, bass, banjo, violin, ukulele, or mandolin.

17. The method as in claim 9, wherein the fabric includes velveteen.

18. The method as in claim 9, the thermoplastic elastomer comprising styrene-ethylene/butylene-styrene block copolymer.

19. A method of making a finish protector for a musical instrument, the method comprising the steps of:
providing a velveteen fabric having a first face and a second face;
providing an unwind roll containing the velveteen rolled thereon;
heating a pelletized combination of mineral oil and styrene-ethylene/butylene-styrene block copolymer;
applying a thin film of molten combination to the first face of the fabric to form a sheet;
positioning a rewind roll distal the unwind roll for receiving the sheet;
positioning a hot roll between the unwind roll and the rewind roll, the hot roll configured to engage the second face of the fabric amid in a location upstream of the die, so that an area of the fabric first engages the hot roll before molten thermoplastic isomer is sprayed onto the area;
cooling the sheet by
positioning a chill roll between the unwind roll and the rewind roll so that the chill roll engages the thin film;
spreading the sheet flat;
removably adhering a backing to the sheet so that the thin film is between the backing and the fabric;
stamping a selected pattern onto the sheet;
removing a stamped figure of the selected pattern from the sheet;
positioning a rewind roll distal the unwind roll for receiving the sheet; wherein,
the fabric is rolled from the unwind roll and the sheet is received on the rewind roll.
